(19) United States
(12) Patent Application Publication
(10) Pub. No.: US 2026/0148430 A1
(43) Pub. Date: May 28, 2026

(54) SELF-IMPROVING DIFFUSION MODELS WITH SYNTHETIC DATA

(71) Applicant: ADOBE INC., SAN JOSE, CA (US)

(72) Inventors: Sina Alemohammad, Houston, TX (US); Shruti Agarwal, San Jose, CA (US); John Collomosse, Woking (GB)

(21) Appl. No.: 18/958,493

(22) Filed: Nov. 25, 2024

(51) Int. Cl. G06T 11/00

(52) U.S. Cl. CPC G06T 11/00

(57) ABSTRACT

A method, apparatus, non-transitory computer readable medium, and system for generating synthetic image includes obtaining a prompt indicating an image element. In some cases, a base generation model generates a first score function based on the prompt and an auxiliary image generation model generates a second score function based on the prompt. Additionally, the first score function and the second score function are combined to obtain a combined score function. In some cases, the combined score function includes positive guidance from the first score function and negative guidance from the second score function. A synthetic image that depicts the image element is generated based on the combined score function.

### BACKGROUND

The following relates generally to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for data generation. Embodiments of the present disclosure include a base image generation model and an auxiliary image generation model for optimizing performance of an image generation model. The image generation model is configured to combine the base image generation model and the auxiliary image generation model based on a backward extrapolation method. In some cases, the auxiliary image generation model is trained based on synthetic data generated by the base image generation model. For instance, the image generation model is trained using the synthetic data that provides negative guidance during the image generation process. As a result, the image generation model is directed towards the ground-truth data distribution which significantly improves the model generation results.

A method, apparatus, non-transitory computer readable medium, and system for image processing are described. One or more aspects of the method, apparatus, non-transitory computer readable medium, and system include obtaining a prompt indicating an image element; generating, using a base image generation model, a first score function based on the prompt; generating, using an auxiliary image generation model, a second score function based on the prompt; combining the first score function and the second score function to obtain a combined score function, wherein the combined score function includes positive guidance from the first score function and negative guidance from the second score function; and generating a synthetic image that depicts the image element based on the combined score function.

A method, apparatus, non-transitory computer readable medium, and system for image processing are described. One or more aspects of the method, apparatus, non-transitory computer readable medium, and system include generating a first score function using a base image generation model; generating a second score function using an auxiliary image generation model, wherein the second score function comprises a negative guidance function; generating a combined score function based on the first score function and the second score function; and generating, using the base image generation model, a synthetic image based on the combined score function

An apparatus and system for image processing are described. One or more aspects of the apparatus and system include a memory component; a processing device coupled to the memory component, the processing device configured to perform operations comprising: obtaining a prompt indicating an image element; generating, using a base image generation model, a first score function based on the prompt; generating, using an auxiliary image generation model, a second score function based on the prompt; combining the first score function and the second score function to obtain a combined score function, wherein the combined score function includes positive guidance from the first score function and negative guidance from the second score function; and generating a synthetic image that depicts the image element based on the combined score function.

### BRIEF DESCRIPTION OF THE DRAWINGS

FIG. 1 shows an example of an image processing system according to aspects of the present disclosure.

FIG. 2 shows an example of a method for generating an image according to aspects of the present disclosure.

FIG. 3 shows an example of an image generation process according to aspects of the present disclosure.

FIG. 4 shows an example of an image generation model according to aspects of the present disclosure.

FIG. 5 shows an example of a latent diffusion architecture according to aspects of the present disclosure.

FIG. 6 shows an example of a U-Net architecture according to aspects of the present disclosure.

FIG. 7 shows an example of a denoising diffusion process according to aspects of the present disclosure.

FIG. 8 shows an example of a method for image processing according to aspects of the present disclosure.

FIG. 9 shows an example of a method of training a ML model according to aspects of the present disclosure.

FIG. 10 shows an example of a method of training a diffusion model according to aspects of the present disclosure.

FIG. 11 shows an example of a computing device according to aspects of the present disclosure.

FIG. 12 shows an example of an image processing apparatus according to aspects of the present disclosure.

FIG. 13 shows an example of an image generation model according to aspects of the present disclosure.

### DETAILED DESCRIPTION

The present disclosure describes systems and methods for data generation. Embodiments of the present disclosure include a base image generation model and an auxiliary image generation model for optimizing performance of an image generation model. The image generation model is configured to combine the base image generation model and the auxiliary image generation model based on a backward extrapolation method. In some cases, the auxiliary image generation model is trained based on synthetic data generated by the base image generation model. For instance, the image generation model is trained using the synthetic data that provides negative guidance during the image generation process. As a result, the image generation model is directed towards the ground-truth data distribution which significantly improves the model generation results.

In some cases, existing machine learning methods are increasingly pressured to train on synthetic data due to the requirement of training increasingly large generative models. However, training a new generative model with synthetic data results in a self-consuming loop (i.e., autophagy) that gradually degrades the quality and diversity of the synthetic data with number of iterations. For instance, as the iterations progress, the model deviates from the ground-truth data distribution until the predictions no longer resemble the original data. That is, the data generated by the model is significantly different from the ground-truth data resulting in model collapse.

By contrast, embodiments of the present disclosure are configured to perform processing of synthetic data differently from the ground-truth data. In some cases, the image generation model of the present disclosure comprises a diffusion network that uses the synthetic data (e.g., self-synthesized data, i.e., data generated by the base image generation model) to provide negative guidance during the image generation process. For instance, by implementing negative guidance based on the synthetic data, embodiments of the present disclosure are able to direct the image generation process towards the ground-truth data (i.e., directed away from the non-ideal synthetic data).

An embodiment of the present disclosure includes an image generation model that is configured to simultaneously enhance the modeling process of the diffusion network and a result of the image generation process. In some cases, the image generation model is able to adjust the synthetic data distribution of the diffusion network. For instance, the synthetic data distribution is aligned with a desired in-domain target distribution resulting in low bias in the generated data.

According to an embodiment of the present disclosure, the image generation model improves a score function of a base image generation model. For instance, the base image generation model comprises a diffusion network. For instance, the base image generation model is trained using ground-truth data. In some cases, the image generation model enhances the score function for the base image generation model based on training an auxiliary image generation model. For instance, the auxiliary image generation model comprises a diffusion network.

According to an embodiment, the auxiliary image generation model is trained based on the ground-truth data and the synthetic data. In some cases, a score function of the auxiliary image generation model is combined with the score function of the base image generation model to extrapolate a score function for the image generation model. For instance, the score function of the image generation model is close to the ground-truth data.

The image generation model of the present disclosure is configured to significantly enhance the generation quality of a diffusion network based on synthetic data (e.g., self-synthesized data). In some cases, combining the ground-truth data and the synthetic data to train the image generation model results in an improved performance compared to the base image generation model and the auxiliary image generation model. For instance, the image generation model is iteratively trained on the synthetic data based on a guidance parameter.

According to an embodiment of the present disclosure, the image generation model is able to adjust the synthetic data distribution to align with a desired in-domain target distribution which results in low data biases and enhanced generation quality. Thus, by reversing the trajectory of the score functions, embodiments of the present disclosure are able to prevent generation of biased samples. For instance, embodiments are able to generate data that is close to the ground-truth data when the combined score function is repeatedly extrapolated.

Accordingly, by using the synthetic data generated by the base image generation model to provide negative guidance to the image generation model during the image generation process, embodiments of the present disclosure are able to efficiently and accurately guide the generation process of the image generation model away from the non-ideal synthetic data. Thus, embodiments of the present disclosure are able to guide the image generation process towards the real data distribution which results in generated images being more similar to the ground-truth and real-data distribution.

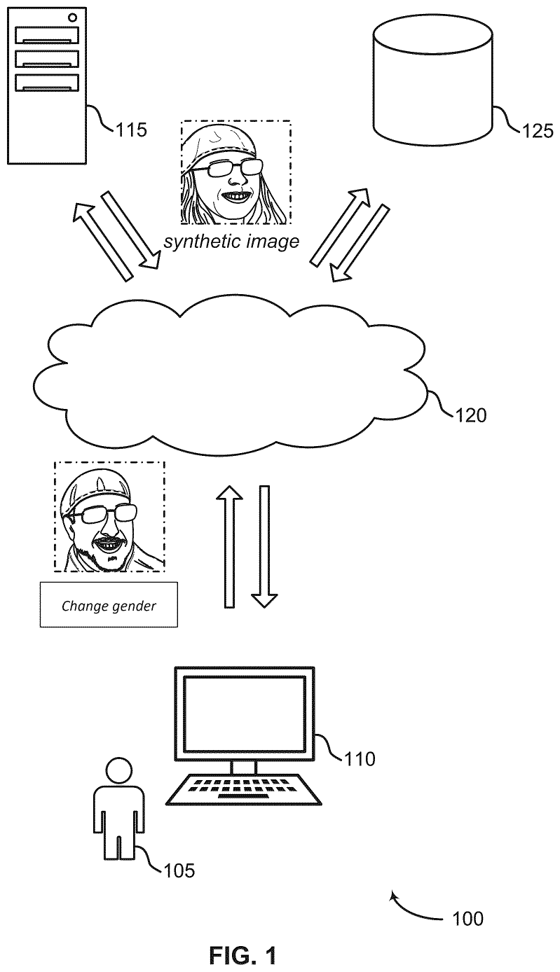

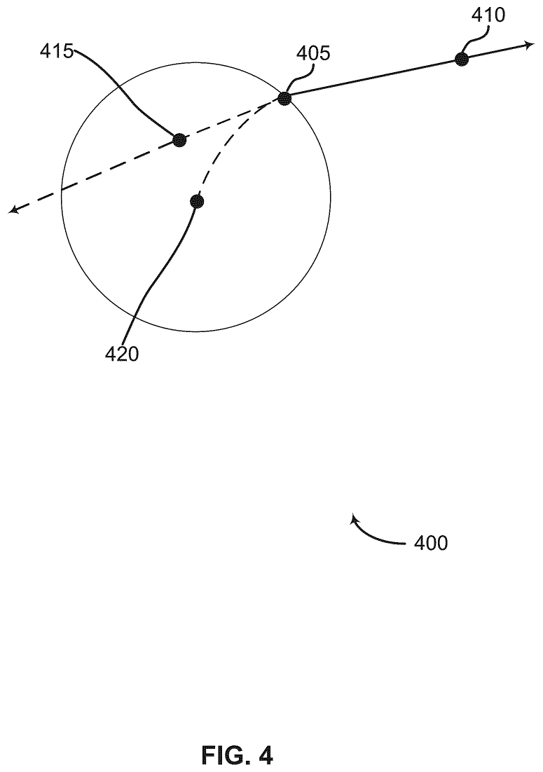

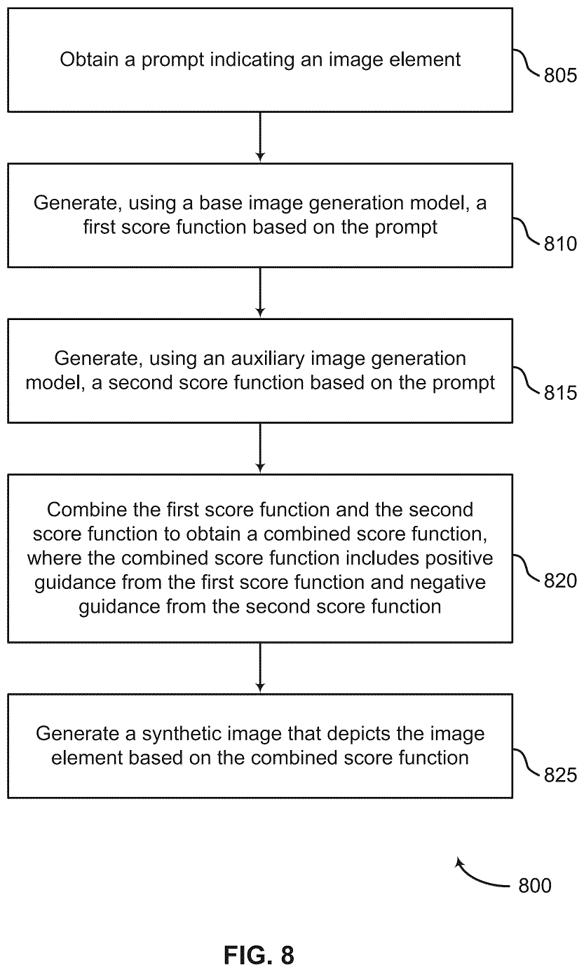

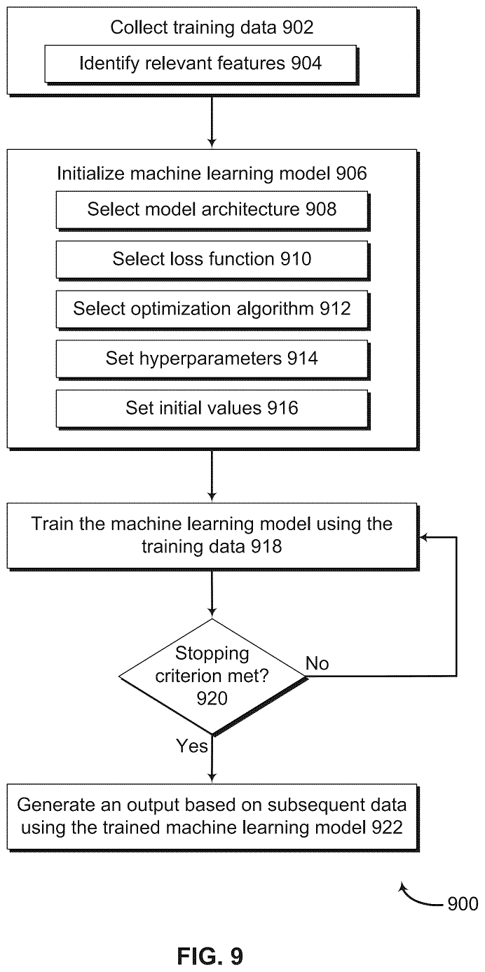

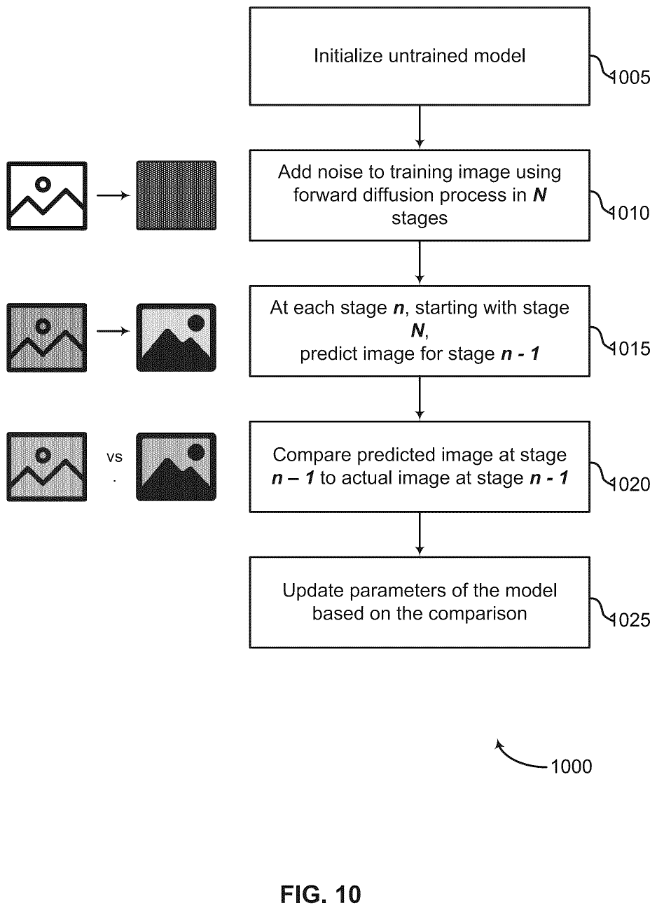

Embodiments of the present disclosure can be implemented in an image generation model. For example, the image generation model based on the present disclosure takes an input prompt (e.g., describing an element) and generates an output image that accurately depicts the element described in the prompt. Example applications regarding generating an output that depicts an element are provided with reference to FIGS. 1-3. Details regarding the architecture of the image generation model are provided with reference to FIGS. 4-7 and 11-13. Details regarding a process of operation of the image generation model are provided with reference to FIG. 8. Examples of a process for training the image generation model are provided with reference to FIGS. 9-10.

### Image Generation System

A system and an apparatus for image processing are described with reference to FIGS. 1-7. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides a prompt describing an action to image processing apparatus 115 via a user interface provided on user device 110 by image processing apparatus 115. In some cases, the input prompt is an input text. Additionally, for example, user 105 provides an input image to image processing apparatus 115 via the user interface. As shown in FIG. 1, the input prompt describes an action based on which the user wants to modify the input image using the image processing apparatus 115 of the present disclosure. According to some aspects, the image processing apparatus 115 obtains an input image and an input prompt, i.e., describing an action to be taken on the input image.

In some cases, the image processing apparatus 115 implements an image generation model (such as the image generation model described with reference to at least FIG. 4) to generate a synthetic image that modifies the input image based on the input prompt. In some cases, as shown in FIG. 1, the user provides an input prompt (e.g., a text prompt) to the image processing apparatus 115, aspects of which the user wants to depict in the synthetic image. In some examples, the image processing apparatus generates a synthetic image that accurately modifies the input image to match the action provided by the input prompt.

According to an exemplary embodiment of the present disclosure, the image processing apparatus 115 is able to perform simultaneous self-improvement and distribution shifting using a dataset comprising high-quality images of human faces. For instance, the dataset comprises images of faces varying in gender, age, and race, with an almost equal split of male and female humans.

In some examples, image processing apparatus 115 is able to adapt to an arbitrary target distribution. For example, user 105 wants to construct a distribution that overrepresents females compared to males, e.g., changing the percentage to 70% female and 30% male instead of 50.3% female and 49.7% male. In some examples, user 105 provides an input prompt to image processing apparatus 115 (e.g., as shown in FIG. 1 to change gender for female overrepresentation).

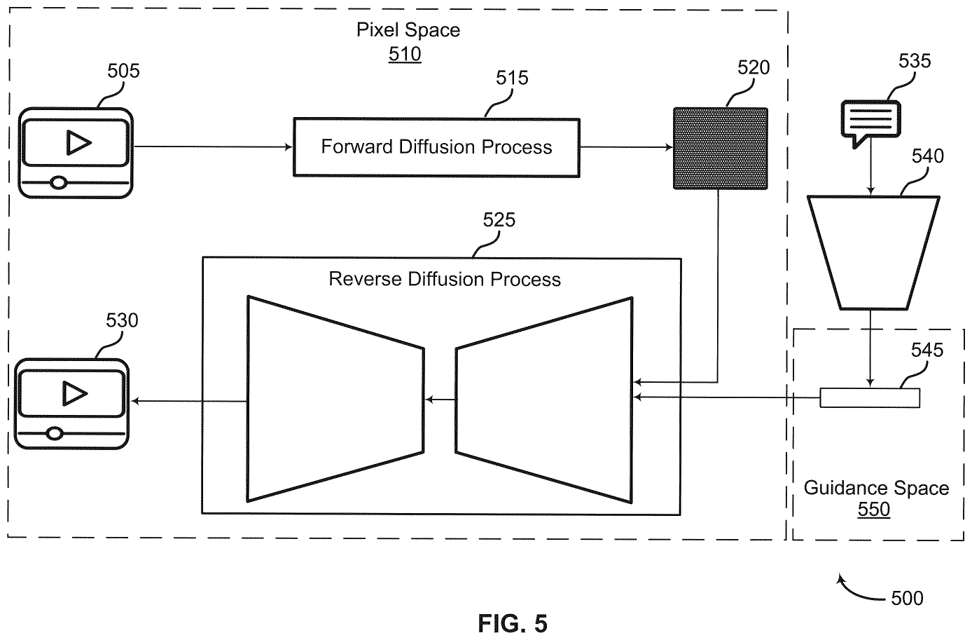

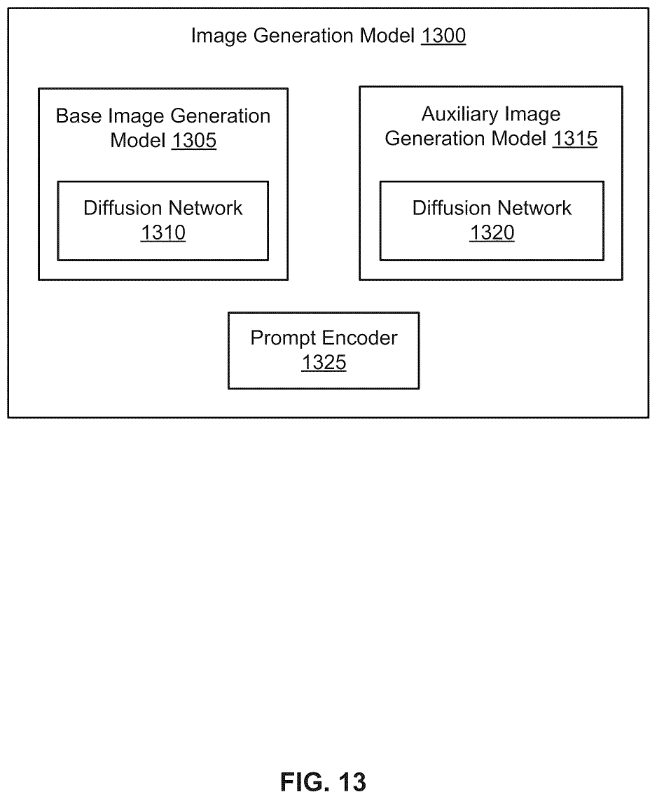

Accordingly, based on the input prompt, image processing apparatus 115 (such as image processing apparatus described with reference to FIG. 4) uses a pre-trained classifier to label the perceived genders of the generated faces using a base image generation model (such as diffusion model described with reference to FIGS. 5-7). In some cases, a score function of an auxiliary image generation model (such as auxiliary image generation model described with reference to FIGS. 4 and 13) is used as a negative guidance. In some cases, the distribution generated by the auxiliary image generation model is a complement of the target distribution.

According to an embodiment, the auxiliary image generation model is obtained by fine-tuning the pre-trained diffusion model using the human faces dataset. In some cases, the score function of the base image generation model and the auxiliary image generation model are combined using a guidance strength. In some examples, the distribution shifting is performed by varying the guidance strength. Further details regarding the base image generation model and the auxiliary image generation model are provided with reference to FIGS. 4 and 12-13.

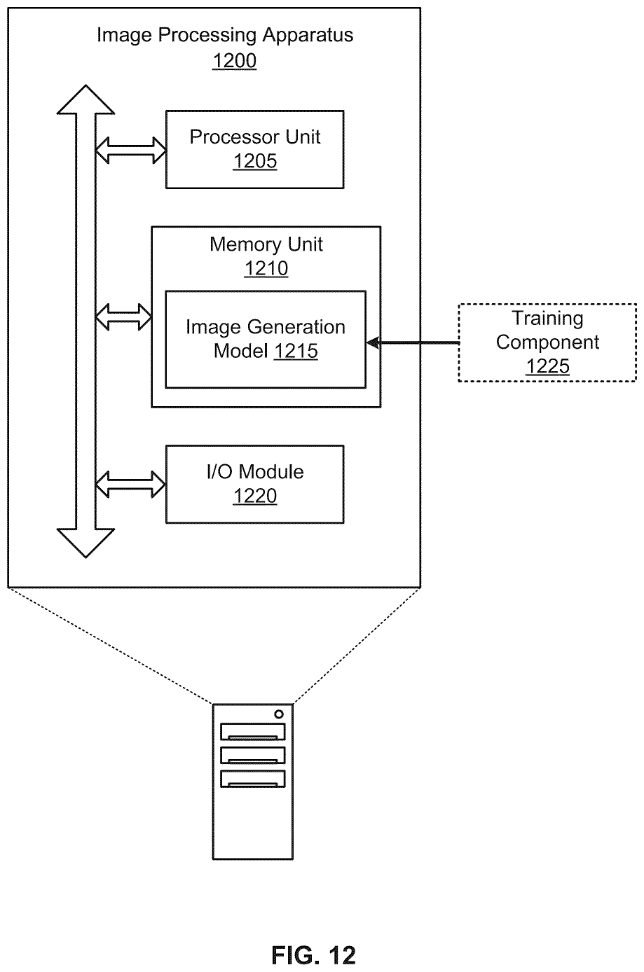

Referring to the example of FIG. 1, the image processing apparatus 115 generates the synthetic image that depicts a modified gender of the input image which enables distribution shifting in the provided dataset. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIG. 12.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

According to some aspects, image processing apparatus 115 includes a computer-implemented network. In some embodiments, the computer-implemented network includes a machine learning model (such as the machine learning model described with reference to FIGS. 4-7). In some embodiments, image processing apparatus 115 also includes one or more processors, a memory subsystem, a communication interface, an I/O interface, one or more user interface components, and a bus as described with reference to FIG. 13. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

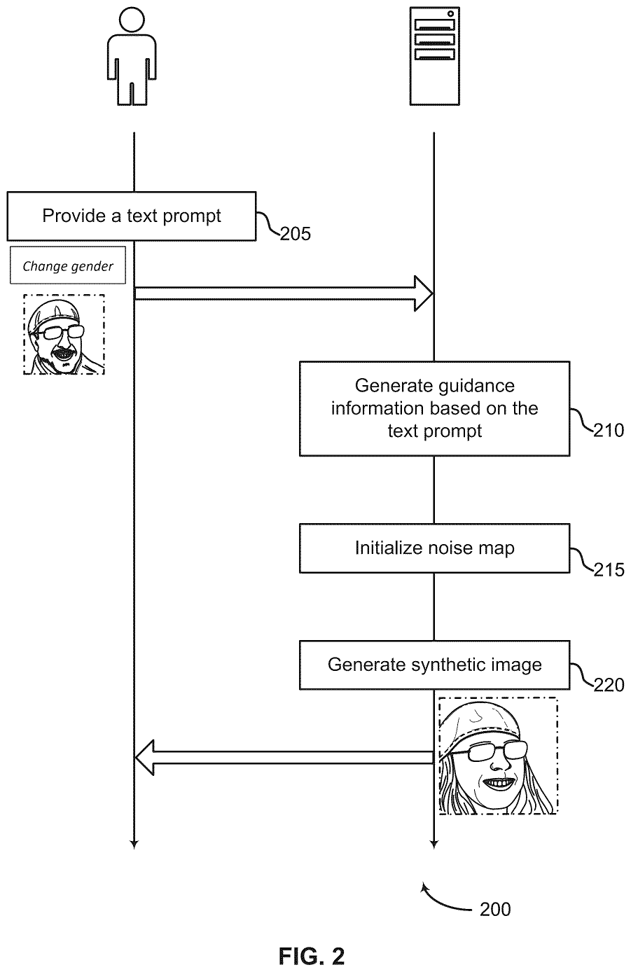

FIG. 2 shows an example of a method 200 a method for generating an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

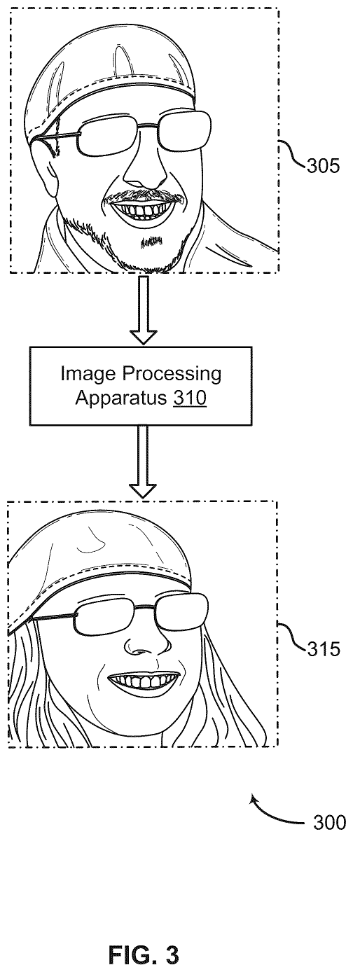

According to an embodiment of the present disclosure, an image processing apparatus (such as the image processing apparatus described with reference to FIGS. 3 and 12) provides a machine learning model (such as the image generation model described with reference to FIGS. 4-7 and 12-13) that accurately generates a synthetic image depicting the action described in the input text prompt as being incorporated into an element of the input image.

At operation 205, the system provides a text prompt. In some cases, the operations of this step refer to, or may be performed by, a user as described with reference to FIG. 1. Additionally, the user provides an image to the image processing apparatus. In some cases, the text prompt provides an instruction based on which the user wants to modify the input image. For example, the user provides an input image depicting a human face and a prompt instructing the image processing apparatus to “Change gender”.

At operation 210, the system generates guidance information based on the text prompt. In some cases, the operations of this step refer to, or may be performed by, an image processing apparatus as described with reference to FIG. 1.

In some cases, the image processing apparatus converts the text prompt into guidance information (such as a conditional guidance vector or other multi-dimensional representation). For example, text prompt is converted into a vector or a series of vectors using a transformer model, or a multi-modal encoder. In some cases, the encoder for the conditional guidance is trained independently of the diffusion model.

At operation 215, the system initializes noise map. In some cases, the operations of this step refer to, or may be performed by, an image processing apparatus as described with reference to FIG. 1.

In some cases, the noise map includes random noise. The noise map may be in a pixel space or a latent space. By initializing a media item with random noise, different variations of a media item including the content described by the conditional guidance can be generated.

At operation 220, the system generates a synthetic image. In some cases, the operations of this step refer to, or may be performed by, an image processing apparatus as described with reference to FIG. 1. For example, the synthetic image is generated based on the noise map and the conditional guidance vector. For example, the synthetic image is generated using an image generation model as described with reference to FIG. 4. The synthetic image is provided to the user via a user interface of the user device.

FIG. 3 shows an example of an image generation process 300 according to aspects of the present disclosure. In one aspect, image generation process 300 includes input image 305, image processing apparatus 310, and output image 315.

Referring to FIG. 3, input image 305 depicts a human face a user (such as the user described with reference to FIGS. 1-2) wants to modify. In some cases, the user wants to change a gender distribution of a dataset. For instance, the user provides input image 305 to image processing apparatus 310 along with an input prompt, such as a text prompt indicating the user's desire to “change gender” which will shift a gender distribution of the dataset. Input image 305 is an example of, or includes aspects of, the corresponding element described with reference to FIG. 1.

The image processing apparatus 310 (such as the image processing apparatus described with reference to FIGS. 1-2, 4, and 12) of the present disclosure receives the input image 305 and input prompt (such as input prompt described with reference to FIGS. 1-2) from the user. In some cases, the image processing apparatus 310 modifies the input image 305 to generate output image 315 that matches aspects of the input prompt. For instance, the image processing apparatus 310 generates output image 315 that depicts a woman (using input image 305) based on the input prompt. Output image 315 is an example of, or includes aspects of, the synthetic image or synthetic output described with reference to FIGS. 1-2 and 4.

FIG. 4 shows an example of an image generation model 400 according to aspects of the present disclosure. In one aspect, image generation model 400 includes first score function 405, second score function 410, and combined score function 415.

An embodiment of the present disclosure includes an image generation model comprising a self-improving diffusion model. In some cases, the image generation model uses synthetic data generated by a base image generation model (such as base image generation model described with reference to FIG. 1 and base image generation model 1305 described with reference to FIG. 13) training to improve real data modeling and synthesis. For instance, the image generation model implements guidance capabilities that efficiently guide the image generation model away from the generated synthetic data.

According to an embodiment, synthetic data from the base image generation model is used to obtain a synthetic score function (such as base image generation model described with reference to FIG. 1 and base image generation model 1305 described with reference to FIG. 13). In some cases, the synthetic score function is used to provide negative guidance to the image generation model during the image generation process (such as the image generation process described in FIG. 8).

Embodiments of the present disclosure include an image generation model configured to generate a synthetic image that is resembles the ground-truth image. In some cases, the image generation model generates the synthetic image by reversing a trajectory (such as the trajectory described herein to obtain a combined score function 415 that is closer to the ground-truth 420.

As shown with reference to FIG. 4, the circle indicates the region in the function space of score functions that is inaccessible to a learning algorithm due to factors such as a limited amount of real data or sampling noise. Accordingly, training the base image generation model exclusively on real data results in a first score function 405 s_{θ}_{ᵣ}(xₜ, t) (parameterized by a learnable neural network with parameters θᵣ) in the vicinity of ground truth 420.

In some cases, when an auxiliary image generation model (such as auxiliary image generation model described with reference to FIG. 1 and auxiliary image generation model 1315 described with reference to FIG. 13) is trained by fine-tuning the base image generation model with synthetic data from the base image generation model, second score function 410 is obtained. As shown with reference to FIG. 4, second score function 410 s_{θ}_{ₛ}(xₜ, t) is further away from ground-truth 420 than the first score function 405.

According to an embodiment of the present disclosure, the image processing apparatus is configured to linearly extrapolate the first score function 405 and second score function 410 to the inaccessible region (e.g., inside the circle). For instance, the second score function 410 of the auxiliary image generation model is combined with the first score function 405 of the base image generation model to extrapolate a combined score function 415. As shown with reference to FIG. 4, the combined score function 415 is closer to the real data distribution (ground-truth 420).

An embodiment of the present disclosure generates synthetic data from the image generation model using the combined score function. In some cases, the combined score function is generated based on an untrained diffusion model (such as a base image generation model), a collection of samples [symbol] drawn from a real data distribution pᵣ, a synthetic dataset size n, and guidance strength ω.

In some cases, dataset [symbol] is used to train the base image generation model resulting in the first score function 405 s_{θ}_{ᵣ}(xₜ, t). In some cases, the auxiliary image generation model is trained. For instance, a synthetic dataset [symbol] is generated using n samples from the base image generation model. In some examples, the base image generation model is finetuned using [symbol] to obtain second score function 410 s_{θ}_{ₛ}(xₜ, t).

According to an embodiment, the second score function 410 s_{θ}_{ₛ}(xₜ, t) is extrapolated backwards from first score function 405 s_{θ}_{ᵣ}(xₜ, t) to obtain the combined score function 415:

$${s}_{θ} ( {x}_{t} , t ) = {s}_{{θ}_{r}} ( {x}_{t} , t ) - ω ( {s}_{{θ}_{s}} ( {x}_{t} , t ) - {s}_{{θ}_{r}} ( {x}_{t} , t ) ) = ( 1 + ω ) {s}_{{θ}_{r}} ( {x}_{t} , t ) - ω {s}_{{θ}_{s}} ( {x}_{t} , t ) \qquad ( 1 )$$

The present disclosure describes an image generation model that simultaneously improves a diffusion network modeling process and a synthetic performance. In some cases, the image generation model improves the first score function s_{θ}_{ᵣ}(xₜ, t) for the base image generation model trained on real data by training the auxiliary image generation model on the real data (e.g., same real data) and on the output of the base image generation model. The second score function s_{θ}_{ₛ}(xₜ, t) of the auxiliary image generation model is combined with the first score function s_{θ}_{ᵣ}(xₜ, t) of the base image generation model to extrapolate a combined score function 415 that is close to the real data distribution (e.g., ground-truth 420).

In some cases, p denotes real data distribution for modeling. For instance, a diffusion network gradually diffuses the training data over time t∈[0, T] and samples from p by inversely modeling the forward diffusion process (such as the forward diffusion process as described with reference to FIG. 5). In some cases, the diffusion process includes transforming instances from p into noisy versions with scaling aₜ data and incrementally increasing the level of additive noise according to the schedule σₜ time t.

In some cases, the conditional distribution of the noisy sample xₜ at time t is formalized as:

$${q}_{t} ( {x}_{t} \vert {x}_{0} ) = 𝒩 ( {x}_{t} \vert μ = {a}_{t} {x}_{0} , Σ = {σ}_{t} I ) \qquad ( 2 )$$

where x₀ is the data instance from p. The diffusion process is formalized using a stochastic differential equation (SDE) as:

$$d x = f ( x , t ) dt + g ( t ) d w \qquad ( 3 )$$

where w is the standard Wiener process. In some cases, the different choices for f(x, t) and g(t) result in different scaling and noise schedules aₜ, σₜ in Equation 2. The solution to the SDE in Equation 3 is given as:

$$d x = [ f ( x , t ) - {g}^{2} ( t ) {∇}_{{x}_{t}} log {q}_{t} ( {x}_{t} ) ] d t + g ( t ) d \overline{w} \qquad ( 4 )$$

where dw̅ is the standard Wiener process when the time flows in the reverse direction, and qₜ is the unconditional distribution in Equation 2 obtained by the forward SDE using Equation 3.

The solution of the SDE in Equation 4 starting from the samples of x_{T}˜q_{T} results in samples x˜q₀(x₀) that enable data generation from p. In some cases, the neural network is trained with parameters θ to approximate the score function s_{θ}(xₜ, t)≈∇ₓ_{ₜ} log qₜ(xₜ) using:

$${min}_{θ} \frac{1}{\vert 𝒟 \vert} {\sum }_{{x}_{0} ∈ 𝒟} {𝔼}_{t ∈ [ 0 , T ] , {x}_{t} ∼ {q}_{t} ( {x}_{t} \vert {x}_{0} )} [ λ ( t ) {‖ {s}_{θ} ( {x}_{t} , t ) - {∇}_{{x}_{t}} log {q}_{t} ( {x}_{t} ) ‖}^{2} ] \qquad ( 5 )$$

where [symbol] the training set comprising samples from p, and λ(t) is a temporal weighting function. The SDE in Equation 4 is solved by replacing ∇ₓ_{ₜ} log qₜ(xₜ) with s_{θ}(xₜ, t) and performing numerical integration. In some cases, for a conditional generation process, a condition is implemented on the score function during training to obtain the condition score.

FIG. 5 shows an example of a guided diffusion model 500 according to aspects of the present disclosure. In some examples, guided diffusion model 500 describes the operation and architecture of the image generation model 1215 described with reference to FIG. 12 or image generation model 1300 described with reference to FIG. 13. The guided latent diffusion model 500 depicted in FIG. 5 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 500 may take an original media item 505 in a pixel space 510 as input and apply forward diffusion process 515 to gradually add noise to the original media item 505 to obtain noisy media item 520 at various noise levels.

Next, a reverse diffusion process 525 (e.g., a U-Net) gradually removes the noise from the noisy media item 520 at the various noise levels to obtain an output media item 530. In some cases, an output media item 530 is created from each of the various noise levels. The output media item 530 can be compared to the original media item 505 to train the reverse diffusion process 525.

The reverse diffusion process 525 can also be guided based on a text prompt 535, or another guidance prompt, such as an image, a layout, a segmentation map, etc. The text prompt 535 can be encoded using a text encoder 565 (e.g., a multimodal encoder) to obtain guidance features 545 in guidance space 550. The guidance features 545 can be combined with the noisy media item 520 at one or more layers of the reverse diffusion process 525 to ensure that the output media item 530 includes content described by the text prompt 535. For example, guidance features 545 can be combined with the noisy features using a cross-attention block within the reverse diffusion process 525.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 4, 6-7 and 12-13.

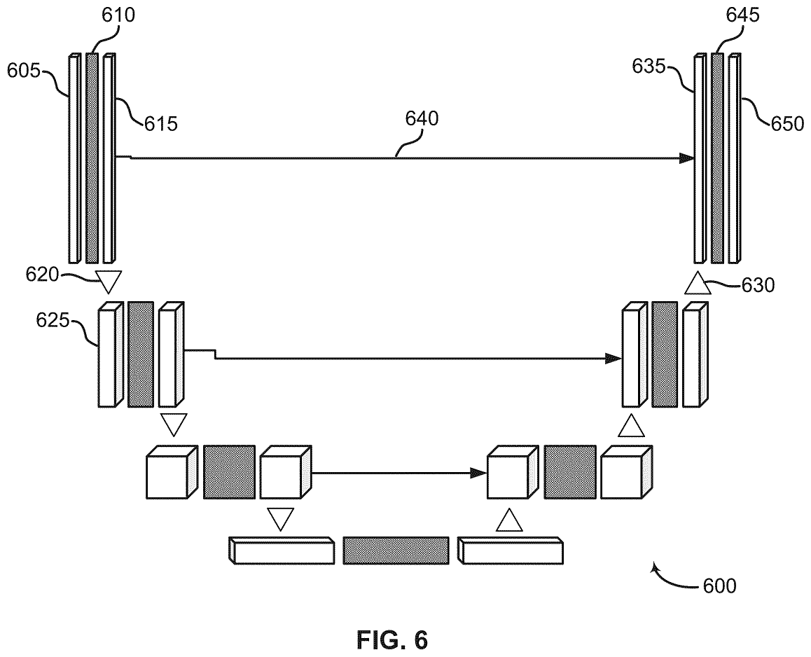

FIG. 6 shows an example of a U-Net 600 according to aspects of the present disclosure. In some examples, U-Net 600 is an example of the component that performs the reverse diffusion process 525 of guided diffusion model 500 described with reference to FIG. 5 and includes architectural elements of the image generation model 1215 described with reference to FIG. 12 or image generation model 1300 described with reference to FIG. 13. The U-Net 600 depicted in FIG. 6 is an example of, or includes aspects of, the architecture used within the reverse diffusion process described with reference to FIG. 5.

In some examples, diffusion models are based on a neural network architecture known as a U-Net. The U-Net 600 takes input features 605 having an initial resolution and an initial number of channels and processes the input features 605 using an initial neural network layer 610 (e.g., a convolutional network layer) to produce intermediate features 615. The intermediate features 615 are then down-sampled using a down-sampling layer 620 such that down-sampled features 625 features have a resolution less than the initial resolution and a number of channels greater than the initial number of channels.

This process is repeated multiple times, and then the process is reversed. That is, the down-sampled features 625 are up-sampled using up-sampling process 630 to obtain up-sampled features 635. The up-sampled features 635 can be combined with intermediate features 615 having the same resolution and number of channels via a skip connection 640. These inputs are processed using a final neural network layer 645 to produce output features 650. In some cases, the output features 650 have the same resolution as the initial resolution and the same number of channels as the initial number of channels.

In some cases, U-Net 600 takes additional input features to produce conditionally generated output. For example, the additional input features could include a vector representation of an input prompt. The additional input features can be combined with the intermediate features 615 within the neural network at one or more layers. For example, a cross-attention module can be used to combine the additional input features and the intermediate features 615. U-Net architecture is an example of, or includes aspects of, the corresponding element described with reference to FIGS. 4 and 6.

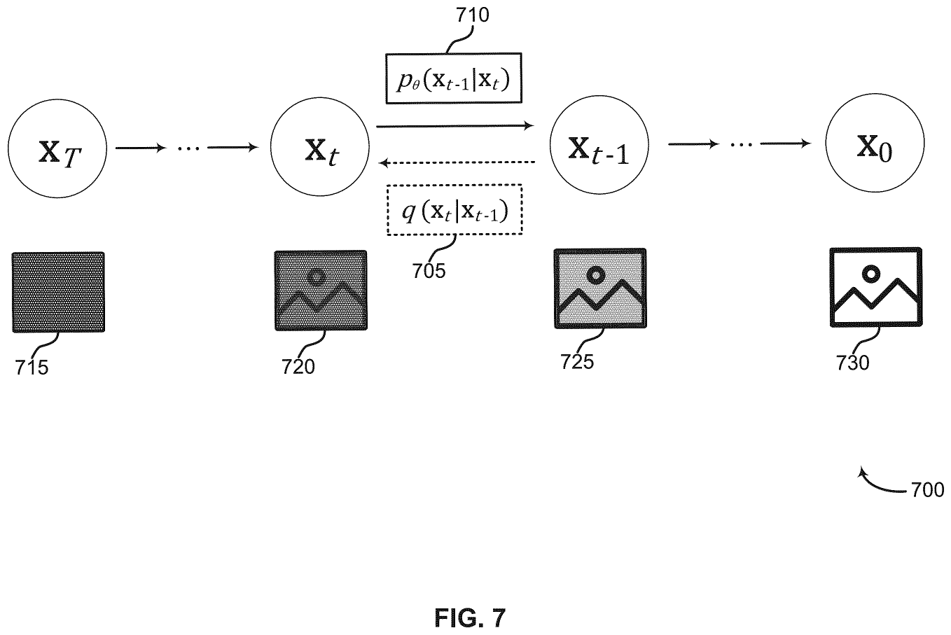

FIG. 7 shows a diffusion process 700 according to aspects of the present disclosure. In some examples, diffusion process 700 describes an operation of the image generation model 1215 described with reference to FIG. 12 or image generation model 1300 described with reference to FIG. 13, such as the reverse diffusion process 525 of guided diffusion model 500 described with reference to FIG. 5.

As described above with reference to FIG. 5, using a diffusion model can involve both a forward diffusion process 705 for adding noise to a media item (or features in a latent space) and a reverse diffusion process 710 for denoising the media item (or features) to obtain a denoised media item. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate media items with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , X_{T} using a Markov chain. The Markov chain gradually adds Gaussian noise to the data to obtain the approximate posterior q(x_{1:T}|x₀) as the latent variables are passed through a neural network such as a U-Net, where x₁, . . . , X_{T} have the same dimensionality as x₀.

The neural network may be trained to perform the reverse process. During the reverse diffusion process 710, the model begins with noisy data x_{T}, such as a noisy media item 715 and denoises the data to obtain the p(xₜ₋₁|xₜ). At each step t−1, the reverse diffusion process 710 takes xₜ, such as first intermediate media item 720, and t as input. Here, t represents a step in the sequence of transitions associated with different noise levels, The reverse diffusion process 710 outputs xₜ₋₁, such as second intermediate media item 725 iteratively until x_{T} reverts back to x₀, the original media item 730. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 6 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 7 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 4-6, 10, and 12-13.

Accordingly, an apparatus for image processing is described. One or more aspects of the apparatus include a memory component; a processing device coupled to the memory component, the processing device configured to perform operations comprising: obtaining a prompt indicating an image element; generating, using a base image generation model, a first score function based on the prompt; generating, using an auxiliary image generation model, a second score function based on the prompt; combining the first score function and the second score function to obtain a combined score function, wherein the combined score function includes positive guidance from the first score function and negative guidance from the second score function; and generating a synthetic image that depicts the image element based on the combined score function.

In some aspects, the base image generation model comprises a diffusion model. In some aspects, the auxiliary image generation model comprises a diffusion model. In some aspects, the auxiliary image generation model is trained based on an output of the base image generation model.

Some examples of the apparatus and system further include a prompt encoder configured to generate a prompt embedding. Some examples of the apparatus and system further include an image generation model trained based on the synthetic image.

### Image Generation Process

The present disclosure describes systems and methods for image processing. Embodiments of the present disclosure include an image generation model configured to guide an image generation process based on synthetic data. In some cases, the image generation model uses the generated synthetic data to obtain a synthetic score function which is used to provide negative guidance during the image generation process. By using the synthetic data to provide negative guidance, embodiments of the present disclosure are able to direct the generation process towards the ground-truth data (i.e., direct away from the synthetic data).

In some cases, for a training dataset [symbol] and algorithm [symbol] (⋅), a generative model is obtained with distribution [symbol] , i.e., [symbol] . In some cases, a sequence of generative models is considered as [symbol] for t∈ [symbol] , where each model approximates a reference probability distribution pᵣ. In some cases, an existing image generation system includes an autophagous loop. For instance, the autophagous loop is a sequence of distributions [symbol] , where each generative model [symbol] is trained on data that includes samples from previous generation models

$${( {𝒢}^{τ} )}_{τ - 1}^{t - 1} .$$

In some cases, dist(⋅,⋅) denotes a distance metric on a distribution. A generative process according to model autophagy is a sequence of distributions [symbol] such that [symbol] [dist( [symbol] ^{t}, pᵣ)] increases with t. For instance, a self-consuming loop is based on the generation of [symbol] from a dataset that comprises ground-truth data (e.g., real data) from pᵣ, i.e.,

$${𝒟}_{r}^{t} ,$$

and synthetic data from the model [symbol] denoted by

$${𝒟}_{s}^{t} .$$

For instance, the base image generation model is trained solely on ground-truth (real) data, i.e., [symbol] . In case of a subsequent generation model, [symbol] , t≥2. Particularly, in case of a synthetic loop, the model [symbol] ^{t} (for t≥2) trains exclusively on synthetic data sampled from a previous generation model, i.e.,

$${𝒟}^{t} = {𝒟}_{s}^{t - 1} .$$

In case of a synthetic augmentation loop, the model [symbol] ^{t} (for t≥2) trains on a dataset

$${𝒟}^{t} = ( {𝒟}_{r} , {𝒟}_{s}^{t - 1} ) ,$$

i.e., a fixed set of ground-truth (real) data [symbol] from pᵣ, and synthetic data

$${𝒟}_{s}^{t - 1}$$

from models of previous generations. In case of fresh data loop, the model [symbol] ^{t} (for t≥2) trains on a dataset

$${𝒟}^{t} = ( {𝒟}_{r}^{t} , {𝒟}_{s}^{t - 1} ) ,$$

i.e., a fresh set of real data

$${𝒟}_{r}^{t}$$

from pᵣ, and synthetic data

$${𝒟}_{s}^{t - 1}$$

from models of previous generations.

Embodiments of the present disclosure include an image generation model configured to prevent performance degradation in a self-consuming loop. In some cases, the image generation model is configured to maintain and enhance the performance of a base image generation model (i.e., [symbol] [dist( [symbol] ,pᵣ)]≤ [symbol] [dist( [symbol] ,pᵣ)]). For instance, the image generation model of the present disclosure implements the synthetic augmentation loop as the training algorithm resulting in prevention of model autophagy. Thus, the image generation model uses self-generated synthetic data for enhancing performance of a diffusion network (i.e., referred to as self-improvement). The image generation model is described herein with reference to an unconditional diffusion network. However, embodiments are not limited thereto, and the image generation model may be implemented on a conditional diffusion network.

FIG. 8 shows an example of a method 800 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

An embodiment of the present disclosure includes an image generation model configured to improve a diffusion network. In some cases, the image generation model uses synthetic data generated by the diffusion network for the improvement, i.e., self-improvement. For instance, the image generation model of the present disclosure uses the generated synthetic data as negative guidance for the image generation process. In some cases, the image generation model is able to adjust a generated output based on performing an alignment with a desired in-domain target distribution. In some cases, the image generation model is used to correct data bias and enhance fairness of a diffusion network.

At operation 805, the system obtains a prompt indicating an image element. In some cases, the operations of this step refer to, or may be performed by, an image processing apparatus as described with reference to FIGS. 1 and 12.

For example, in some cases, the user interface of the image processing apparatus (such as image processing apparatus 1200 described with reference to FIG. 12) receives an input prompt from a user. In some examples, the input prompt describes an element that the user wants to incorporate in the generated image (e.g., synthetic image). In some examples, the image processing apparatus receives the input prompt from a database or any other data source. Additionally or alternatively, the user interface receives an input image from the user. In some examples, the input prompt describes the element that user wants to modify in the input image.

At operation 810, the system generates a first score function based on the prompt. In some cases, the operations of this step refer to, or may be performed by, a base image generation model as described with reference to FIG. 13.

In some cases, the base image generation model is characterized by a first score function s_{θ}_{ᵣ}(xₜ, t) that is trained on ground-truth data (e.g., real data samples) from a target distribution pᵣ. In some cases, at a given point xₜ at noise level t, the first score function s_{θ}_{ᵣ}(xₜ, t) outputs a vector zᵣ. For instance, the vector zᵣ points in the direction of increasing log probability density log pᵣ. In some cases, an output that follows the synthetic data distribution (i.e., pₛ) is obtained by numerically solving the reverse SDE in Equation 4 (described with reference to FIG. 4) using the first score function s_{θ}_{ᵣ}(xₜ, t). In some examples, the synthetic data distribution pₛ does not match the target distribution pᵣ due to factors such as, but not limited to, the size of the training data, inaccuracies in solving the reverse SDE, implicit algorithmic biases, etc. resulting in model induced distribution shift.

At operation 815, the system generates a second score function based on the prompt. In some cases, the operations of this step refer to, or may be performed by, an auxiliary image generation model as described with reference to FIG. 13.

In some cases, the auxiliary image generation model is trained using the same training hyperparameters used for obtaining s_{θ}_{ᵣ}(xₜ, t) using dataset [symbol] comprising samples from the synthetic data distribution pₛ. As a result, a second score function s_{θ}_{ₛ}(xₜ, t) is generated. For instance, the first score function s_{θ}_{ᵣ}(xₜ, t) and the second score function s_{θ}_{ₛ}(xₜ, t) are approximations of data distributions pᵣ and pₛ, respectively. In some cases, the difference between the first score function and the second score function is used as a substitute for the model induced distribution shift.

At operation 820, the system combines the first score function and the second score function to obtain a combined score function, where the combined score function includes positive guidance from the first score function and negative guidance from the second score function. In some cases, the operations of this step refer to, or may be performed by, an image generation model as described with reference to FIGS. 4 and 13.

In some examples, the image generation model is guided away from the difference of the second score function and the first score function (i.e., s_{θ}_{ₛ}(xₜ, t)−s_{θ}_{ᵣ}(xₜ, t)) during the generation process which reduces the model induced distribution shift. In some cases, the combined score function used for generation is given as:

$$\begin{matrix}{s}_{θ} ( {x}_{t} , t ) = {s}_{{θ}_{r}} ( {x}_{t} , t ) - ω ( {s}_{{θ}_{s}} ( {x}_{t} , t ) - {s}_{{θ}_{r}} ( {x}_{t} , t ) ) \\ = ( 1 + ω ) {s}_{{θ}_{r}} ( {x}_{t} , t ) - ω {s}_{{θ}_{s}} ( {x}_{t} , t )\end{matrix} \qquad ( 8 )$$

where ω is the guidance strength. Further details regarding generation of the combined score are provided with reference to at least FIG. 4.

At operation 825, the system generates a synthetic image that depicts the image element based on the combined score function. In some cases, the operations of this step refer to, or may be performed by, an image generation model as described with reference to FIGS. 4 and 13.

In some cases, the image generation model generates the synthetic image based on the combined score function. For example, the image generation model generates the image that depicts the element indicated by the user in the input prompt. In some cases, the image is generated via a reverse diffusion process based on the combined score function as described with reference to FIGS. 4-6. In some cases, the synthetic image is generated using multiple iterations of the image generation model (e.g., multiple forward passes of a reverse diffusion process described with reference to FIGS. 5-7). In some cases, the image processing apparatus provides the synthetic image to the user via the user interface.

Accordingly, a method for image processing is described. One or more aspects of the method include obtaining a prompt indicating an image element; generating, using a base image generation model, a first score function based on the prompt; generating, using an auxiliary image generation model, a second score function based on the prompt; combining the first score function and the second score function to obtain a combined score function, wherein the combined score function includes positive guidance from the first score function and negative guidance from the second score function; and generating a synthetic image that depicts the image element based on the combined score function.

Some examples of the method, apparatus, non-transitory computer readable medium, and system further include obtaining a noise map. Some examples further include denoising the noise map based on the combined score function.

Some examples of the method, apparatus, non-transitory computer readable medium, and system further include generating a training image using the base image generation model. Some examples further include training the auxiliary image generation model using the training image.

Some examples of the method, apparatus, non-transitory computer readable medium, and system further include training an image generation model using the synthetic image as training data. Some examples of the method, apparatus, non-transitory computer readable medium, and system further include identifying a weight parameter, wherein the first score function and the second score function are combined based on the weight parameter.

Some examples of the method, apparatus, non-transitory computer readable medium, and system further include encoding the prompt to obtain a prompt embedding, wherein the first score function and the second score function are generated based on the prompt embedding. In some aspects, the second score function represents an unnatural image artifact.

### Training

Embodiments of the present disclosure include an image generation model configured to enhance a performance of the generation results. In some cases, the image generation model comprises a diffusion network. For instance, the image generation model enhances a performance of the diffusion network based on synthetic data generated by a base image generation model.

In some cases, given the base diffusion network trained on a set of ground-truth data and a set of synthetic data (e.g., data synthetized from the diffusion network), embodiments of the present disclosure are configured to combine the ground-truth data and the synthetic data to generate a combined score function. For instance, the combined score function is obtained by a backward extrapolation of a score of an auxiliary image generation model and a score of a base image generation model. In some cases, the image generation model of the present disclosure generates synthetic output using the combined score function.

According to an embodiment, the base image generation model is trained using a ground-truth data to generate a first score function. In some cases, the auxiliary image generation model is trained using synthetic data generated by the base image generation model. For instance, the synthetic data is obtained by generating a plurality of samples from the base image generation model and fine-tuning the base image generation model using the synthetic data to obtain a second score function of the auxiliary image generation model.

In some examples, a size of the synthetic dataset nₛ=| [symbol] | influences the effectiveness of the image generation model. As nₛ→∞, the image generation model essentially learns the first score function s_{θ}_{ᵣ}(xₜ, t) independently which eliminates the role of guidance information (e.g., guidance strength ω as described with reference to FIGS. 4 and 8). Additionally or alternatively, for small values of nₛ, the estimate of the first score function s_{θ}_{ᵣ}(xₜ, t) is inaccurate resulting in ineffective guidance. In some cases, the image generation model uses nₛ as a hyperparameter.

In some cases, training an image generation model with various values of nₛ incurs a high computational cost. Accordingly, an embodiment of the present disclosure fine-tunes the first score function s_{θ}_{ᵣ}(xₜ, t) using dataset [symbol] to obtain the first score function s_{θ}_{ᵣ}(xₜ, t) for a single value n.

As a result, a case where nₛ→∞ is obtained at the beginning of training and the value of nₛ gradually changes to n (i.e., nₛ=n) as the fine-tuning process progresses. In some cases, different snapshots of the image generation model are obtained during the fine-tuning process that approximately correspond to the complete training process of the image generation model. Thus, the snapshots are obtained for n≤nₛ<∞ which effectively map different values of nₛ to various stages of the training process for the first score function s_{θ}_{ᵣ}(xₜ, t).

According to an embodiment of the present disclosure, training of the base image generation model and the auxiliary image generation model is performed using the same optimization objective (e.g., provided with reference to Equation 5 described in FIG. 4) and the same training hyperparameters. In some cases, the image generation model based on the combined score function is evaluated for different values of guidance strength and training process of the auxiliary image generation model.

FIG. 9 shows an example of a method of training a machine learning model according to aspects of the present disclosure. FIG. 9 is a flow diagram depicting an algorithm as a step-by-step procedure 900 in an example implementation of operations performable for training a machine-learning model. In some embodiments, the procedure 900 describes an operation of the training component 1225 described for configuring the image generation model 1215 as described with reference to FIG. 12. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model. The machine learning model, is an example of, or includes aspects of, the corresponding element described with reference to FIGS. 2, 4-7, and 12-13.

FIG. 10 shows an example of a method of training a diffusion model 1000 according to aspects of the present disclosure. In some embodiments, the method 1000 describes an operation of the training component 1225 described for configuring the image generation model 1215 as described with reference to FIG. 12. The method 1000 represents an example for training a reverse diffusion process as described above with reference to FIGS. 5-7. In some examples, these operations are performed by a system including a processor executing a set of codes to control functional elements of an apparatus, such as the guided diffusion model described in FIG. 5.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, according to some aspects, a training component (such as the training component 1225 described with reference to FIG. 12) trains a diffusion model (such as the image generation model described with reference to FIGS. 4-8) to generate an output.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image (or an additional training image) using a forward diffusion process (such as the forward diffusion process described with reference to FIG. 5) in N stages. In some cases, the operations of this step refer to, or may be performed by, a training component as described with reference to FIG. 12.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

### Implementation and Evaluation

An exemplary embodiment of the present disclosure is configured to perform performance evaluation of the image generation model. For instance, the image generation model uses twice the number of function evaluations at inference time due to the auxiliary image generation model. In some examples, the number of function evaluations are reduced with minimal impact on performance by applying guidance from the auxiliary image generation model within a limited interval. Additionally or alternatively, the number of function evaluations are reduced by fine-tuning only a portion of the base model to obtain the auxiliary image generation model.

An exemplary embodiment of the present disclosure is configured to evaluate a synthetic dataset size for training the auxiliary image generation model, Fréchet inception distance (FID) for different number of function evaluations, and strategies for reducing number of function evaluations during inference. For example, the dataset size used for training the second score function of the auxiliary image generation model is changed and the FID values are provided as the training progresses.

In some examples, increasing the dataset size provides for improved values of FID. In some cases, when | [symbol] |→∞, the first score function and the second score function are identical (i.e., s_{θ}_{ₛ}(xₜ, t)→s_{θ}_{ᵣ}(xₜ, t)), use of negative guidance does not impact the generation process. For instance, increasing the synthetic dataset to large numbers may result in decrease in FID.

In some cases, the number of function evaluations (NFE) refers to the number of times a score function is evaluated during denoising. The image generation model of the present disclosure uses a high number of function evaluations to achieve low FID. For instance, at NFE=40, FID for a diffusion network with and without guidance cases is approximately equal to 1.70. The image generation model uses a guidance strength of ω=0.9 and the FID auxiliary image generation model trained to 56 Mi during training. In case of a fixed denoising step, the image generation model uses twice the NFE compared to the base image generation model without any guidance which results in twice the inference time computation.

According to an exemplary embodiment, the weights of an encoder and a decoder of the model are frozen during the finetuning of the base image generation model. During an inference time, the encoder is shared between the base image generation model and the auxiliary image generation model (i.e., each of the base image generation model and the auxiliary image generation model differ in the decoder). Accordingly, the effective NFE decreases from 2 times to 1.5 times. Additionally, the auxiliary image generation model increases the minimum FID from 0.92 to 1.01 during fine-tuning and reduces the NFE from 2 to 1.5 while training only the decoder.

According to an exemplary embodiment, the guidance strength from the auxiliary image generation model is applied for a limited time interval. Accordingly, the FID of the image generation model is computed with guidance strength applied to a limited time interval (tₗ, tₕ) (i.e., instead of (0, 32)) to assess the impact of guidance strength at different denoising steps. For instance, guidance strength is critical during the last denoising steps (instead of the earlier denoising steps). In some examples, the first ten steps in the denoising process is excluded with a reduction in FID from 0.93 to 0.96. Therefore, use of the auxiliary image generation model for guidance over a small number of intervals can effectively reduce inference time and costs.

An exemplary embodiment of the present disclosure is configured to train the base image generation model and the auxiliary image generation model. In some examples, the base image generation model is trained using open source (e.g., publicly available) pre-trained model weights. In some examples, the auxiliary image generation model is trained using synthetic data generated by the base image generation model.

An embodiment of the present disclosure uses FID values to estimate the distance between the distribution of a generative model and a reference probability distribution. For instance, the said distance is denoted as dist( [symbol] , pᵣ). As described herein, the image generation model generates the auxiliary image generation model by finetuning the base image generation model and combining the score functions to generate a combined score function.

In some examples, the FID values of the image generation model are evaluated during finetuning of the auxiliary image generation model. In some cases, the FID values are modified by varying the guidance strength between (0, 3) with an interval of 0.1. The lowest value of FID is obtained corresponding to an optimal guidance strength. Additionally, an optimal degree of finetuning is associated with each value of the guidance strength.

The image generation model of the present disclosure significantly outperforms existing diffusion networks. An exemplary embodiment of the present disclosure indicates that scaling the number of parameters is not able to match the performance obtained by training an auxiliary image generation model with synthetic data. Additionally, the image generation model of the present disclosure significantly outperforms discriminator guidance which indicates that reducing the probability under the synthetic distribution for every denoising step provides improved performance compared to increasing the realism score via a discriminator.

An exemplary embodiment of the present disclosure includes an image generation model configured to prevent the negative impacts of synthetic data training. In some cases, a two-dimensional Gaussian distribution, pᵣ= [symbol] (μ,Σ) is learnt using a diffusion network, where mean μ=[0,0]^{T} and covariance Σ=[2,1; 1,2]. In some cases, a ground-truth (real) dataset [symbol] of size | [symbol] |=1000 is collected from [symbol] (ρ, Σ) and the first generation model is trained [symbol] . Next, a synthetic augmentation loop is generated for a future generation of the model, where for any iteration t in the loop,

$${𝒢}^{t} = 𝒜 ( {𝒟}_{r} , {𝒟}_{s}^{t - 1} ) ,$$

where

$${𝒟}_{s}^{t - 1}$$

is synthetic data generated from the previous generation model [symbol] . In some examples, the performance of the model ( [symbol] [dist( [symbol] ,pᵣ)]) is quantified using Wasserstein distance for dist(⋅,⋅).

According to an exemplary embodiment, the image generation model is trained on

$${𝒟}^{t} = ( {𝒟}_{r} , {𝒟}_{s}^{t - 1} )$$

based on the base image generation model and the auxiliary image generation model. In case of a self-consuming loop, a fixed guidance strength ω is used for each generation of the image generation model. In some examples, the synthetic data [symbol] is generated from the base image generation model trained on

$${𝒟}^{t} = ( {𝒟}_{r} , {𝒟}_{s}^{t - 1} ) .$$

For instance, the synthetic data [symbol] is distinct from the synthetic data

$${𝒟}_{s}^{t - 1}$$

which is generated using the base image generation model and the auxiliary image generation model trained obtained at iteration t−1.

For example, the base image generation model is trained for 100 epochs on the ground-truth (real) dataset [symbol] . In some examples, the auxiliary image generation model is obtained at an iteration t by finetuning the base image generation model for 50 epochs using 2000 data points synthesized from the base image generation model.

An exemplary embodiment of the present disclosure is configured to compute the Wasserstein distance at different iterations. In some examples, at ω=0, the Wasserstein distance increases to a significantly high value resulting in deterioration of the generation results. As the guidance strength ω increases, the Wasserstein distance does not change significantly which reduces the negative impacts of synthetic training. In some examples, the image generation model of the present disclosure prevents performance deterioration in self-consuming loops with diffusion models without providing external knowledge.

The present disclosure describes systems and methods for diffusion based image generation models. The image generation model of the present disclosure uses a small amount of synthetic data to guide the image generation process. In some cases, the image generation model of the present disclosure outperforms existing machine learning models that are trained exclusively on ground-truth (real) data. The image generation model effectively prevents model autophagy for multiple generations when training a diffusion model on Gaussian data.

The image generation model of the present disclosure is able to align the distribution of its generated images with an arbitrary in-domain target distribution P that is distinct from the training data distribution p of the model. In some cases, the image generation model is able to enhance the quality of generated data. Accordingly, embodiments of the present disclosure are able to provide an image generation model that can self-improve and mitigate extant biases in a base image generation model by shifting the model distribution towards a (desired) different distribution.

### Computing Device

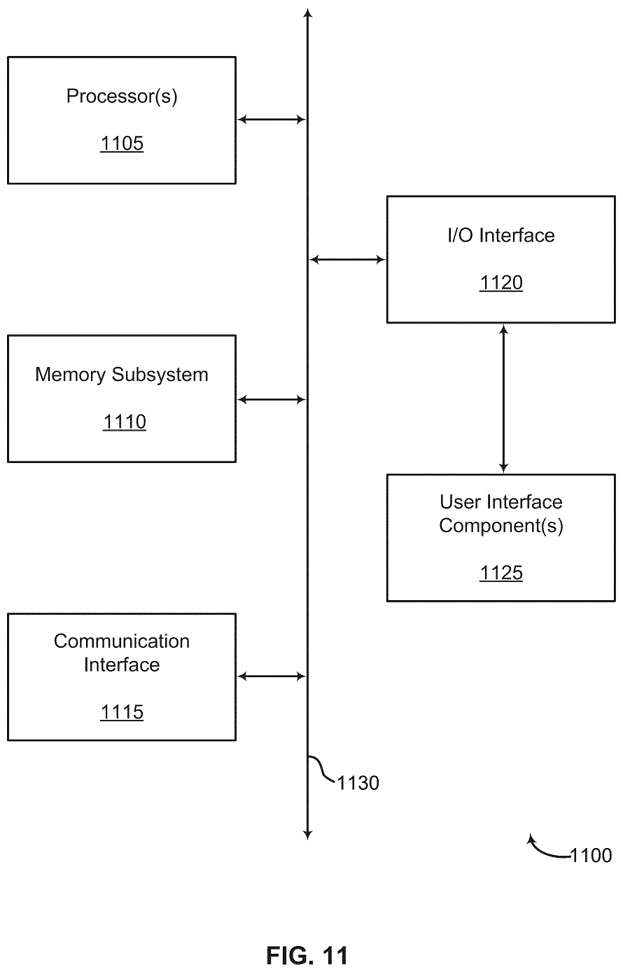

FIG. 11 shows an example of a computing device according to aspects of the present disclosure. The computing device 1100 may be an example of the image processing apparatus 1200 described with reference to FIG. 12. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the image generation model of FIGS. 12-13. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

FIG. 12 shows an example of an image processing apparatus 1200 according to aspects of the present disclosure. Image processing apparatus 1200 is an example of, or includes aspects of, the corresponding element described with reference to FIGS. 1 and 3. According to some aspects, image processing apparatus 1200 obtains a prompt indicating an image element.

In one aspect, image processing apparatus 1200 includes processor unit 1205, memory unit 1210, I/O module 1220, and training component 1225. Training component 1225 updates parameters of the image generation model 1215 stored in memory unit 1210. In some examples, the training component 1225 is located outside the image processing apparatus 1200.

According to some aspects, processor unit 1205 comprises a processing device coupled to the memory component. Processor unit 1205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1205 is configured to operate a memory array using a memory controller. In other cases, a memory controller is integrated into processor unit 1205. In some cases, processor unit 1205 is configured to execute computer-readable instructions stored in memory unit 1210 to perform various functions. In some aspects, processor unit 1205 includes special purpose components for modem processing, baseband processing, digital signal processing, or transmission processing. According to some aspects, processor unit 1205 comprises one or more processors described with reference to FIG. 11.

Memory unit 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1205 to perform various functions described herein.

In some cases, memory unit 1210 includes a basic input/output system (BIOS) that controls basic hardware or software operations, such as an interaction with peripheral components or devices. In some cases, memory unit 1210 includes a memory controller that operates memory cells of memory unit 1210. For example, the memory controller may include a row decoder, column decoder, or both. In some cases, memory cells within memory unit 1210 store information in the form of a logical state. According to some aspects, memory unit 1210 is an example of the memory subsystem 1110 described with reference to FIG. 11.

According to some aspects, image processing apparatus 1200 uses one or more processors of processor unit 1205 to execute instructions stored in memory unit 1210 to perform functions described herein. For example, the image processing apparatus 1200 may obtain a prompt indicating an image element; generate, using a base image generation model, a first score function based on the prompt; and generate, using an auxiliary image generation model, a second score function based on the prompt; combine the first score function and the second score function to obtain a combined score function, wherein the combined score function includes positive guidance from the first score function and negative guidance from the second score function; and generate a synthetic image that depicts the image element based on the combined score function.

In one aspect, memory unit 1210 includes image generation model 1215 trained to obtain a prompt indicating an image element; generate, using a base image generation model, a first score function based on the prompt; and generate, using an auxiliary image generation model, a second score function based on the prompt; combine the first score function and the second score function to obtain a combined score function, wherein the combined score function includes positive guidance from the first score function and negative guidance from the second score function; and generate a synthetic image that depicts the image element based on the combined score function. For example, after training, the image generation model 1215 may perform inferencing operations as described with reference to FIGS. 1-3 to obtain a prompt indicating an image element; generate, using a base image generation model, a first score function based on the prompt; and generate, using an auxiliary image generation model, a second score function based on the prompt; combine the first score function and the second score function to obtain a combined score function, wherein the combined score function includes positive guidance from the first score function and negative guidance from the second score function; and generate a synthetic image that depicts the image element based on the combined score function.

In some embodiments, the image generation model 1215 is an Artificial neural network (ANN) comprising a plurality of networks including the guided diffusion model described with reference to FIG. 5 and the U-Net described with reference to FIG. 6. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

According to some aspects, image generation model 1215 combines the first score function and the second score function to obtain a combined score function, where the combined score function includes positive guidance from the first score function and negative guidance from the second score function. In some examples, image generation model 1215 comprise generates a synthetic image that depicts the image element based on the combined score function. In some examples, image generation model 1215 is trained based on the synthetic image. Image generation model 1215 is an example of, or includes aspects of, the corresponding element described with reference to FIGS. 3-4.

Training component 1225 may train the image generation model 1215. For example, parameters of the image generation model 1215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 9-10). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1215 can be used to make predictions on new, unseen data (i.e., during inference).

FIG. 13 shows an example of an image generation model 1300 according to aspects of the present disclosure. Image generation model 1300 is an example of, or includes aspects of, the corresponding element described with reference to FIG. 4. In one aspect, image generation model 1300 includes base image generation model 1305, auxiliary image generation model 1315, and prompt encoder 1325. That is, the image generation model 1300 can be a combined image generation model that includes base image generation model 1305 and auxiliary image generation model 1315 to create an output that is improved with respect to either of the individual models. In some cases, an output of the base model is used for training the auxiliary model (hence, the auxiliary model may output defects indicative of using synthetic data). In some cases, the output of the image generation model 1300 is suitable for training a subsequent image generation model without resulting in defects indicative of using synthetic training data.

Thus, in the present disclosure, the term “base image generation model” refers to an initial image generation model trained to generate synthetic images. The term “auxiliary image generation model” refers to a separate model which, in some cases, is trained based on synthetic data generated by the base image generation model. However, the auxiliary image generation model can be any model that produces negative guidance. The term “combined image generation model”, including image generation model 1300, refers to a model that uses a combination of the base image generation model and the auxiliary image generation model to generate synthetic images. The output of the combined image generation model can be used to train yet another image generation model separate from the base image generation model, the auxiliary image generation model, or the combined image generation model.

According to some aspects, base image generation model 1305 generates a first score function based on the prompt. In some examples, base image generation model 1305 generates a training image. In some aspects, the base image generation model 1305 includes a diffusion model. For instance, base image generation model 1305 includes diffusion network 1310. The first score function can represent positive (i.e., desired) guidance for denoising an image using a diffusion process.

According to some aspects, auxiliary image generation model 1315 generates a second score function based on the prompt. In some aspects, the second score function represents an unnatural image artifact. For example, the auxiliary image generation model 1315 could be an image generation model trained on synthetic data, or any image generation network that generates unwanted artifacts. Thus, the second score function represents some unwanted image element and can be used as negative guidance. That is, the different models can represent different modes for operating a same model, or different models with a different architecture or that have been trained on different training data (e.g., on synthetic data).

In some embodiments, the base image generation model 1305 and the auxiliary image generation model 1315 can include the same architecture and even the same weights, operating the auxiliary image generation model 1315 may represent some difference in either the weights, the process, or the inputs that results in an undesired output so that it can be used as negative guidance.

According to some aspects, auxiliary image generation model 1315 is a second score function based on the prompt. In some aspects, the auxiliary image generation model 1315 includes a diffusion model. In some aspects, the auxiliary image generation model 1315 is trained based on an output of the base image generation model 1305. In one aspect, auxiliary image generation model 1315 comprises a diffusion network 1320.

According to some aspects, prompt encoder 1325 encodes the prompt to obtain a prompt embedding, where the first score function and the second score function are generated based on the prompt embedding. According to some aspects, prompt encoder 1325 is configured to generate a prompt embedding.

According to some aspects, the image generation model 1305 obtains a noise map and denoises the noise map based on the combined score function including positive guidance from the base image generation model 1305 and negative guidance from the auxiliary image generation model 1315. Further details regarding the diffusion network are provided with reference to FIGS. 5-7.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining a prompt indicating an image element;
generating a first score function using a base image generation model and a second score function using an auxiliary image generation model, wherein the first score function and the second score function are based on the prompt;
combining the first score function and the second score function to obtain a combined score function, wherein the combined score function includes positive guidance from the first score function and negative guidance from the second score function; and
generating a synthetic image that depicts the image element based on the combined score function.

2. The method of claim 1, wherein generating the synthetic image comprises:
obtaining a noise map; and
denoising the noise map based on the combined score function.

3. The method of claim 1, further comprising:
generating a training image using the base image generation model; and
training the auxiliary image generation model using the training image.

4. The method of claim 1, further comprising:
training another image generation model using the synthetic image as training data.

5. The method of claim 1, wherein combining the first score function and the second score function comprises:
identifying a weight parameter, wherein the first score function and the second score function are combined based on the weight parameter.

6. The method of claim 1, further comprising:
encoding the prompt to obtain a prompt embedding, wherein the first score function and the second score function are generated based on the prompt embedding.

7. The method of claim 1, wherein:
the second score function represents an unnatural image artifact.

8. A non-transitory computer readable medium storing code, the code comprising instructions that, when executed by at least one processor, cause the at least one processor to perform operations comprising:
generating a first score function using a base image generation model;
generating a second score function using an auxiliary image generation model, wherein the second score function comprises a negative guidance function;
generating a combined score function based on the first score function and the second score function; and
generating, using the base image generation model, a synthetic image based on the combined score function.

9. The non-transitory computer readable medium of claim 8, wherein generating the synthetic image comprises:
obtaining a noise map; and
denoising the noise map based on the combined score function.

10. The non-transitory computer readable medium of claim 8, the code further comprising instructions that, when executed by the at least one processor, cause the at least one processor to perform operations comprising:
generating a training image using the base image generation model; and
training the auxiliary image generation model using the training image.

11. The non-transitory computer readable medium of claim 8, the code further comprising instructions that, when executed by the at least one processor, cause the at least one processor to perform operations comprising:
training an image generation model using the synthetic image as training data.

12. The non-transitory computer readable medium of claim 8, wherein generating the combined score function comprises:
identifying a weight parameter, wherein the first score function and the second score function are combined based on the weight parameter.

13. The non-transitory computer readable medium of claim 8, the code further comprising instructions that, when executed by the at least one processor, cause the at least one processor to perform operations comprising:
encoding a prompt to obtain a prompt embedding, wherein the first score function and the second score function are generated based on the prompt embedding.

14. The non-transitory computer readable medium of claim 8, wherein:
the second score function represents an unnatural image artifact.

15. A system comprising:
a memory component; and
a processing device coupled to the memory component, the processing device configured to perform operations comprising:
obtaining a prompt indicating an image element;
generating, using a base image generation model, a first score function based on the prompt;
generating, using an auxiliary image generation model, a second score function based on the prompt;
combining the first score function and the second score function to obtain a combined score function, wherein the combined score function includes positive guidance from the first score function and negative guidance from the second score function; and
generating a synthetic image that depicts the image element based on the combined score function.

16. The system of claim 15, wherein:
the base image generation model comprises a diffusion model.

17. The system of claim 15, wherein:
the auxiliary image generation model comprises a diffusion model.

18. The system of claim 15, wherein:
the auxiliary image generation model is trained based on an output of the base image generation model.

19. The system of claim 15, further comprising:
a prompt encoder configured to generate a prompt embedding.

20. The system of claim 15, further comprising:
an image generation model trained based on the synthetic image.
